(19) United States
(12) Patent Application Publication
(10) Pub. No.: US 2014/0065262 A1
(43) Pub. Date: Mar. 6, 2014

(54) METHOD FOR PARTIAL DEGRADATION OF GLUTEN

(71) Applicants: Giammaria GIULIANI, Milano (IT); Anna Benedusi, Milano (IT); Raffaella Di Cagno, Milano (IT); Carlo Giuseppe Rizzello, Bari (IT); Maria De Angelis, Bari (IT); Marco Gobbetti, Bari (IT); Angela Cassone, Bari (IT)

(72) Inventors: Giammaria GIULIANI, Milano (IT); Anna Benedusi, Milano (IT); Raffaella Di Cagno, Milano (IT); Carlo Giuseppe Rizzello, Bari (IT); Maria De Angelis, Bari (IT); Marco Gobbetti, Bari (IT); Angela Cassone, Bari (IT)

(73) Assignee: GIULIANI S.p.A., Milano (IT)

(21) Appl. No.: 13/598,515

(22) Filed: Aug. 29, 2012

(51) Int. Cl. A21D 8/04; A21D 13/00; A21D 10/00

(52) U.S. Cl. CPC A21D 8/045; A21D 10/002; A21D 8/047; A21D 13/00
USPC 426/20; 426/18; 426/549; 426/558

(57) ABSTRACT

The present invention is directed to a method for preparing flour dough with reduced content of gluten starting from gluten containing cereals flours. In particular, the invention is directed to the use of lactic acid bacteria and fungal enzymes for the partial degradation of gluten in wheat flour in order to obtain flour dough with residual gluten concentration from 20,000-80,000 ppm. The flour dough obtained by the method of the invention can be used to prepare food products with reduced gluten content.

### FIELD OF THE INVENTION

The present invention is directed to a method for preparing flour dough with reduced gluten content from gluten containing cereals flours and baked goods obtained using the flour dough with reduced gluten content. The method for preparing flour dough with reduced gluten content according to the invention includes fermentation of cereal flour in the presence of lactic acid bacteria and fungal proteases for 8-20 hours.

### BACKGROUND

Wheat is one of the most widely grown crops with more than 25,000 different cultivars. A large part of this global production is consumed after wheat is processed into bread, other baked goods, pasta and noodles, or, as in the case of Middle East and North Africa, into bulgur and couscous. The presence of gluten proteins in wheat flour makes wheat flour an irreplaceable ingredient for various foods.

Gluten is a structural protein complex abundantly present in wheat, with equivalent proteins found in other cereals (e.g., rye and barley). Although the wide spread of gluten containing grains began 10,000 years ago, in recent years wheat breeding is directed to selection of cultivars with an unusual and elevated content of gluten. The daily human exposure to such elevated levels of gluten suggested the possibility that this evolutionary challenge also created conditions for related human diseases. Wheat allergy (WA) and celiac disease (CD), which are mediated by adaptive immune systems, are the most known diseases related to gluten. Under both these conditions, gluten reaction occurs via T-cell activation at the gastrointestinal mucosa level. Cross-linking between immunoglobulin (Ig)E and gluten epitopes is responsible for WA, and it triggers the release of chemical mediators (e.g., histamine) from basophils and mast cells. CD is an autoimmune disorder, which mainly involves the response of serum anti-tissue transglutaminase (tTG) and anti-endomysial antibodies (EMA). Other cases of reaction to gluten are commonly described as gluten sensitivity (GS), and they do not involve allergic or autoimmune mechanisms. Intestinal (e.g., diarrhea, abdominal discomfort or pain, bloating) or extra-intestinal (headache, lethargy, attention-deficit/hyperactivity disorder, ataxia or recurrent oral ulceration) symptoms are often manifested during GS z(Di Sabatino et al., 2012, “Nonceliac gluten sensitive: sense or sensibility?,” Annals of internal medicine, 156, 309-311). Since the clinical symptoms are somewhat overlapping, the correlation between irritable bowel syndrome (IBS), CD and GS recently received a marked interest.

The spectrum of gluten related disorders is widening, and the marked increase of the prevalence of celiac disease (CD), subclinical CD, wheat allergy (WA) and gluten sensitivity (GS) is becoming a major health problem. Such diffuse epidemiology and the wide range of adverse reactions to gluten, raise the question as why this dietary protein is toxic for so many worldwide individuals. A direct correlation was hypothesized with: (i) the selection of wheat varieties with an elevated gluten content, which was dictated by technology rather than nutritional purposes; (ii) the primary structure of gluten and related proteins, which are unusually rich of glutamine and, especially, of the imino acid proline; and (iii) the large use of chemical or baker's yeast leavening, which does not allow any partial degradation of wheat polymers (e.g., proteins) during food processing (De Angelis et al., 2010, “Mechanism of degradation of immunogenic gluten epitopes from Triticum turgidum L. var. durum by sourdough lactobacilli and fungal proteases,” Applied and Environmental Microbiology, 76, 508-518; Sollid et al., 2009, “Diagnosis and treatment of celiac disease,” Mucosal Immunology, vol. 2, pages 3-7). Apparently, human beings are vulnerable to the effect of gluten ingestion, especially due to the lack of an adequate adaptation of the gastrointestinal and immunological responses. Although these risks are present, the pro-capite consumption of gluten in Europe is 10-20 g per day, with segments of the general population who daily ingest ca. 50 g of gluten or more. All individuals, even those with a low degree of risk, are, therefore, susceptible to some form of gluten reaction during their life span.

It is well established that GS symptoms decrease or disappear after gluten is withdrawn from the diet (Volta et al., 2012, “New understanding of gluten sensitivity,” Nature Reviews Gastroenterology and Hepatology, 9, 295-299). The information about the level of gluten that is responsible for the disease and about the mechanisms that cause digestive problems is scarce. Removal of the immunological trigger (gluten) is the basis for treatment of all diagnosed manifestations. Furthermore, the daily consumption of wheat products with an intermediate content of gluten (significantly lower than the current one) may have a delaying effect on the susceptibility to GS or even cause the absence of symptoms of GS. Indeed, approaches targeting the uptake of toxic gluten peptides through enzyme breakdown, sequestering gluten or restoring the epithelial barrier function were developed at the level of clinical trials (Sollid et al., 2009, “Diagnosis and treatment of celiac disease,” Mucosal Immunology, vol. 2, pages 3-7). Thermal and enzyme treatments to get hypoallergenic or low-gluten wheat flour were proposed for making modified-gluten products, which are tolerated by susceptible individuals (Susanna et al., 2011, “A comparative study of different bio-processing methods for reduction in wheat flour allergens.,” European Food Research and Technology, 233, 999-1006; Sapone et al., 2012, “Spectrum of gluten-related disorders: consensus on new nomenclature and classification,” BMC Medicine, 10, 13).

During the last decade, sourdough lactic acid bacteria were used as sources of proteolytic enzymes to markedly decrease the concentration of gluten during bread or pasta processing. In particular, a pool of selected lactic acid bacteria and fungal proteases, which are routinely used in bakery, caused the complete degradation of gluten to less than 10 ppm during sourdough fermentation (Rizzello et al., 2007, “Highly efficient gluten degradation by lactobacilli and fungal proteases during food processing: new perspectives for celiac disease,” Applied and Environmental Microbiology, 73, 4499-4507). Fungal proteases liberated various sized polypeptides (e.g., 4-40 amino acids) from native proteins, which were subsequently transported inside the lactic acid bacteria cells to be hydrolyzed (De Angelis et al., 2010, “Mechanism of degradation of immunogenic gluten epitopes from Triticum turgidum L. var. durum by sourdough lactobacilli and fungal proteases,” Applied and Environmental Microbiology, 76, 508-518). A large number of intracellular peptidases (e.g., PepN, PepO, PEP, PepX, PepT, PepV, PepQ and PepR) were responsible for the complete hydrolysis of the 33-mer or other synthetic immunogenic polypeptides to free amino acids (Di Cagno et al., 2010, “Gluten-free sourdough wheat baked goods appear safe for young celiac patients: a pilot study,” Journal of Pediatric Gastroenterology & Nutrition. 51, 777-783). Two independent clinical challenges (Greco et al., 2011, “Safety for celiac patients of baked goods made of wheat flour hydrolyzed during food processing,” Clinical Gastroenterology and Hepatology, 9, 24-29; Di Cagno et al., 2010, “Gluten-free sourdough wheat baked goods appear safe for young celiac patients: a pilot study,” Journal of Pediatric Gastroenterology & Nutrition. 51, 777-783) were carried out by daily administration of wheat flour baked goods, which contained the equivalent of 8-10 g of native gluten, to celiac patients under remission. After 60 days of challenge, all celiac patients completely tolerated the baked goods made with hydrolyzed wheat flour. The technical behavior and properties of fully hydrolyzed wheat flour are similar to naturally occurring gluten-free flours (e.g., corn), and the use of structuring agents is needed for making baked goods (Rizzello et al., 2007, “Highly efficient gluten degradation by lactobacilli and fungal proteases during food processing: new perspectives for celiac disease,” Applied and Environmental Microbiology, 73, 4499-4507).

Until now, efforts were mainly directed to preparing gluten-free products where gluten is completely degraded. However, individuals suffering from gluten sensitivity need not consume completely gluten-free products because gluten sensitivity can be prevented or delayed by consuming products with reduced or intermediate content of gluten compared to normal gluten-containing products. Since the consumption of gluten provides nutritional and digestive benefits, it is advisable that individuals with gluten sensitivity consume products with reduced or intermediate content of gluten.

### SUMMARY OF THE INVENTION

It is an object of the invention to provide a method for preparing flour dough with reduced content of gluten starting from gluten containing cereals, to be used for making food products with reduced gluten content.

It is another object of the invention to provide a method for preparing flour dough where the content of gluten is reduced by 20 to 60%, preferably by 40 to 60%, of the original content of gluten in the flour. According to one aspect of the invention, the original content of gluten in the flour may be reduced by partial degradation of gluten by lactic acid bacteria and one or more fungal proteases.

According to one aspect of the invention, the method for preparing flour dough with reduced gluten content comprises a) mixing 20-50% by weight of flour with 50-80% by weight of water comprising a mixture of lactic acid bacteria, Lactobacillus sanfranciscensis DSM22063 and Lactobacillus plantarum DSM 22064, wherein each strain of the lactic acid bacteria is at a cell density of about 10⁶-10¹⁰ cfu/g, preferably about 10⁸ cfu/g; b) adding one or more fungal proteases at a final concentration of 10 to 100 ppm; and c) fermenting, preferably, for 8-20 h at 30-37° C., to obtain the flour dough with reduced gluten content.

According to another aspect of the invention, the method for preparing flour dough with reduced gluten content may further comprise a step of drying the flour dough obtained in step c). According to one embodiment, the step of drying the liquid flour dough preferably provides a dough yield of at least 140-180 (yield is the ratio between the obtained dough weight and the weight of starting flour×100) and most preferably, at least 160. According to another embodiment, the step of drying provides a dough yield of at least 220-260 and most preferably at least 250.

It is another object of the invention to provide flour dough with reduced content of gluten from gluten containing flours, suitable for preparing baked goods or other food products that can be consumed safely by individuals with gluten sensitivity. The dough obtained by the method of the invention can be used to prepare leavened baked goods suitable for consumption by individuals with gluten sensitivity. According to one embodiment, the flour dough obtained by the method of the invention contains 20 to 60% less gluten, most preferably 40-60% less gluten, compared to the gluten content of unprocessed flour.

It is another object of the invention to provide a method for preparing baked goods with reduced gluten content.

According to one embodiment, the method for preparing a baked good with reduced gluten content comprises a) adding, e.g. 1-2% by weight, baker's yeast and, e.g. 0.1-1.0% by weight, salt to the flour dough with reduced gluten content obtained by the method of the invention; b) kneading the dough obtained in step a); c) fermenting the dough obtained in step b), preferably for 1-3 h at about 30° C.; and d) baking the fermented dough obtained in step c), preferably for about 50 minutes at about 220° C., to obtain a baked good with reduced gluten content.

According to another embodiment, the method for preparing a baked good with reduced gluten content comprises a) adding egg, sugar, butter and baker's yeast to the flour dough with reduced gluten content obtained by the method of the invention; b) kneading the dough obtained in step a); c) fermenting the dough obtained in step b), preferably for about 1.5 h at about 30° C.; and d) baking the fermented dough obtained in step c), preferably for about 50 minutes at about 250° C. to obtain a baked good with reduced gluten content.

### BRIEF DESCRIPTION OF THE DRAWINGS

FIG. 1 shows the concentration of gluten (ppm), the specific volume and the overall acceptability score of breads made with untreated wheat flour and wheat flour subjected to various extents of gluten degradation. The dashed lines indicate values for WG (whole gluten) bread made with untreated wheat flour and used as the reference, and ICG (intermediate content of gluten) bread made with wheat flour according to the method of the invention.

FIG. 2 shows a two-dimensional gel electrophoretic (2-DE) analysis of albumins and globulins extracted from whole gluten (WG) flour (left panel) and flour with reduced gluten content (ICG) (right panel).

FIG. 3 shows a two-dimensional gel electrophoretic (2-DE) analysis of gliadins extracted from whole gluten (WG) flour (left panel) and flour with reduced content of gluten (ICG) (right panel).

FIG. 4 shows a two-dimensional gel electrophoretic (2-DE) analysis of glutenins extracted from whole gluten (WG) flour (left panel) and flour with reduced content of gluten (ICG) (right panel).

FIG. 5 shows a RP-FPLC analysis of water/salt soluble extracts from WG and ICG flours.

FIG. 6 shows the amount of nitric oxide release by human colon adenocarcinoma T84 cells in the presence of LPS (100 ng/ml) (positive control), DMEM (negative control), pepsin-trypsin (PT) digest of WG flour, PT digest of ICG flour, and fully hydrolyzed wheat flour (FHWF as a second negative control). Data are the means±SD of three separate experiments performed in triplicate. Statistical differences between mean values were determined with Student's T-test. a-d Bars differ significantly (P<0.01).

FIG. 7 shows a difference between the free amino acids profiles of WG flour and ICG flour.

FIG. 8 shows the sensory analysis of breads made with whole gluten flour (WG) and flour with reduced content of gluten (ICG).

### DETAILED DESCRIPTION OF THE INVENTION

According to one aspect of the invention, the method for preparing flour dough with reduced content of gluten starting from gluten containing cereals comprises fermenting cereal flour mixed with water containing desired lactic acid bacteria and fungal proteases, preferably for 8-20 hours.

Prior to fermentation, lactic acid bacteria of the invention, Lactobacillus sanfranciscensis DSM22063 and Lactobacillus plantarum DSM 22064, are cultured, e.g. for 24 hours, harvested, e.g. by centrifugation, washed and re-suspended in water. Preferably, the lactic acid bacteria are suspended at a cell density of about 10⁶-10¹⁰ cfu/g, more preferably at a cell density of about 10⁷-10⁹ cfu/g and most preferably at a cell density of about 10⁸ cfu/g.

The flours that may be used according to the method of the invention include bread wheat flour, durum wheat flour, barley flour, rye flour, oat flour or a mixture thereof. Preferably, the flour comprises bread wheat flour or durum wheat flour.

Preferably, 20-50% by weight of flour is mixed with 50-80% by weight of water comprising a mixture of lactic acid bacteria to prepare flour dough with reduced gluten content. According to one embodiment, 30% by weight of flour may be mixed with 70% by weight of water comprising a mixture of lactic acid bacteria to prepare flour dough according to the invention. According to another embodiment, 40% by weight of flour may be mixed with 60% by weight of water comprising a mixture of lactic acid bacteria to prepare flour dough according to the invention. The weight percentages are based on the total weight of the flour composition.

The fungal proteases can be obtained from Aspergillus oryzae or Aspergillus niger or mixtures thereof. According to the invention, the fungal proteases may be added at a final concentration of 10-100 parts per million (ppm). Preferably, fungal proteases are added at a final concentration of 30-70 ppm and most preferably at a final concentration of 50 ppm. According to one aspect of the invention, the fungal protease added to the flour dough may comprise 25 ppm of Aspergillus oryzae proteases and 25 ppm of Aspergillus niger proteases.

The present invention is also directed to the liquid or dried flour dough obtained by the method of the invention. According to one aspect of the invention, the liquid or dried flour dough obtained by the method of the invention contains at least 20,000 ppm of gluten. According to another aspect of the invention, the liquid or dried flour dough obtained by the method of the invention contains at least 50,000 ppm of gluten. According to yet another aspect of the invention, the liquid or dried flour dough contains from 20,000-80,000 ppm of gluten, preferably from 40,000-60,000 ppm of gluten.

The liquid or dried flour dough of the invention can be used further to prepare baked goods or other food products with reduced gluten content. According to one aspect, the invention provides a method for preparing a baked good with a reduced gluten content wherein the flour dough with reduced gluten content is mixed with baker's yeast and by weight of salt, kneaded, fermented, and baked. According to another aspect, the invention provides a method for preparing a baked good with a reduced gluten content wherein the flour dough with reduced gluten content is mixed with egg, sugar, butter, and baker's yeast, kneaded, fermented, and baked. Although the previously described time and temperature parameters for the step of fermentation and baking are preferred, varying the parameters in order to optimize the productivity and/or taste of baked goods is within the scope of the invention.

The present invention is illustrated by the following examples, which are set forth to illustrate certain embodiments of the present invention and are not to be construed as limiting.

### EXAMPLES

Data reported in the following Examples were analyzed by one-way ANOVA; pair-comparison of treatment means was achieved by Tukey's procedure at P<0.05, using the statistical software Statistica 8.0 (StatSoft Inc., Tulsa, USA).

### Example 1

### Microorganisms and Enzymes

Strains of lactic acid bacteria, Lactobacillus sanfranciscensis 7A, LS3, LS10, LS19, LS23, LS38 and LS47, Lactobacillus alimentarius 15M, Lactobacillus brevis 14G, and Lactobacillus hilgardii 51B were selected based on peptidase activities (Di Cagno et al., 2002, “Proteolysis by sourdough lactic acid bacteria: effects on wheat flour protein fractions and gliadin peptides involved in human cereal intolerance,” Applied and Environmental Microbiology, 68, 623-633; Dewar et al., 2006, “The toxicity of high molecular weight glutenin subunits of wheat to patients with coeliac disease,” European Journal of Gastroenterology & Hepatology, 18, 483-91), and used in this study. Strains were propagated for 24 h at 30° C. in modified MRS broth (Oxoid, Basingstoke, Hampshire, United Kingdom), with the addition of fresh yeast extract (5%, vol/vol) and 28 mM maltose, at the final pH of 5.6 (mMRS). When used for sourdough fermentation, cells of lactobacilli were cultivated until the late exponential phase of growth was reached (ca. 12 h). Fungal proteases from Aspergillus oryzae (E1; 500,000 haemoglobin units on the tyrosine basis/g) and Aspergillus niger (E2; 3,000 spectrophotometric acid protease units/g), which are routinely used as improvers in bakery industry, were purchased from BIO-CAT Inc. (Troy, Va.).

### Example 2

### Sourdough fermentation to obtain flour dough with partially degraded gluten

The main characteristics of the wheat flour (from Triticum aestivum v. Appulo) used were as follows: moisture, 10.2%; protein, 10.3% of dry matter (d.m.); fat, 1.8% of d.m.; ash, 0.6% of. d.m.; and total carbohydrates, 76.5% of d.m. Wheat flour and tap water containing ca. 10⁹ cfu/g (cell density in the dough) of each lactic acid bacterium were used for sourdough fermentation at 30° C., under stirring conditions (ca. 200 rpm). Sourdough fermentations were carried out varying, one by one, the following parameters: dough yield (DY, dough weight×100/flour weight), 500, 333 and 250; time of fermentation, 15, 24 and 48 h; and fungal proteases E1 and E2 (ratio 1:1), 0, 50, 100 and 200 ppm. The flour dough obtained after fermentation was characterized.

### Example 3

### Characterization of Flour Dough

### A. Immunological Analyses

The concentration of gluten of the freeze-dried flours was determined through immunological analyses using the R5 antibody-based sandwich ELISA. The analysis was carried out with the Transia plate detection kit, following the instructions of the manufacturer (Diffchamb, Vastra, Frolunda, Sweden). The R5 monoclonal antibody and the horseradish peroxidase-conjugated R5 antibody were used.

As determined by R5 antibody-based ELISA, the untreated wheat flour contained ca. 82,000 ppm of immune reactive gluten. The degradation of gluten was proportional to the increases of dough yield, time of fermentation and concentration of fungal proteases. The limit of ca. 20,000 ppm of residual gluten was identified as the lowest concentration of gluten for making breads without the use of structuring agents.

### B. Two-Dimensional Electrophoresis (2-DE) Analysis and Isoelectric Focusing (IEF)

Proteins were selectively extracted from whole gluten (WG) wheat flour and wheat flour with intermediate content of gluten (ICG) obtained according to the invenion by the method of Osborne (Osborne, 1907, “The proteins of the wheat kernel,” Carnegie Institute of Washington, publication 84, Washington, D.C: Judd and Dutweiller), further modified by Weiss, Vogelmeier, & Gorg (“Electrophoretic characterization of wheat grain allergens from different cultivars involved in bakers' asthma,” 1993, Electrophoresis, 14, 805-816). The concentration of proteins was determined by the Bradford method (Bradford, 1976, “A rapid and sensitive method for the quantitation of microgram quantities of protein utilizing the principle of protein-dye binding,” Analytical Biochemistry, 72, 248-254).

Two-dimensional electrophoresis (2-DE) was carried out with the immobiline-polyacrilamide system as described by Bjellqvist et al. (“The focusing positions of polypeptides in immobilized pH gradients can be predicted from their amino acid sequences,” 1993, Electrophoresis, 14, 1023-1031) and Di Cagno et al. (“Proteolysis by sourdough lactic acid bacteria: effects on wheat flour protein fractions and gliadin peptides involved in human cereal intolerance,” 2002, Applied and Environmental Microbiology, 68, 623-33). Aliquots of 30 μg of proteins were used for the electrophoretic run. Isoelectric focusing (IEF) was carried out on immobiline strips, providing a non-linear pH gradient from 3.0 to 10.0 (IPG strips; Amersham Pharmacia Biotech, Uppsala, Sweden), for albumin/globulin and glutenin fractions, or a linear pH gradient 6-11, for gliadin fraction, by IPG-phore at 20° C. The second dimension was carried out in a Laemmli system (Laemmli, 1970, “Cleavage of structural proteins during the assembly of the head of bacteriophage T4,” Nature, 227, 680-685) on 12% polyacrilamide gels (13 cm by 20 cm by 1.5 mm) at a constant current of 40 mA/gel and at 15° C. for approximately 5 h, until the dye front reached the bottom of the gel. Gels were silver stained and spot intensities were normalized as reported by Bini et al. (“Protein expression profiles in human breast ductal carcinoma and histologically normal tissue,” Electrophoresis, 18, 2832-2841, 1997).

Before freeze-drying, the ICG flour dough had values of pH and total titratable acidity (TTA) of 4.30±0.3 and 6.2±0.2 ml of 0.1N NaOH/10 g, respectively. As estimated by plating on MRS agar, the number of lactic acid bacteria was ca. 5.0×10⁹ cfu/g. After freeze-drying, the ratio between protein fractions significantly (P<0.05) differed from ICG to WG flours. In particular, the concentration of the water/salt soluble fraction increased from 41.1±0.2 (WG) to 62.5±0.3% (ICG). The fractions of gliadins and glutenins, respectively, decreased from 27.6±0.3 and 31.32±0.2% (VVG) to 12.2±0.3 and 25.2±0.2% (ICG).

TABLE 1
Estimated molecular mass range (kDa) and pI of polypeptides found in
whole gluten (WG) flour, and related percentage of hydrolysis
(hydrolysis factor^{a}, %) after fermentation by selected lactic
acid bacteria and fungal proteases at 30° C. for 15 h.

| | | | |
|---|---|---|---|
| | Estimated | | |
| | molecular | | Hydrolysis |
| | mass range | Estimated pI | factor |
| Spot numbers^{b} | (kDa) | range | range (%) |

Albumins/globulins

| | | | |
|---|---|---|---|
| 1-3 | 75.4 | 7.00-7.20 | 100 |
| 4, 43 | 49.7-75.4 | 5.60-6.85 | 0 |
| 5-42, 44-116 | 38.7-66.2 | 4.40-8.75 | 100 |
| 117-118 | 38.6 | 7.40-7.65 | 0-10 |
| 119-132 | 37.2-38.5 | 4.35-8.25 | 90-100 |
| 133, 137-138 | 36.9-37.2 | 6.75-7.75 | 0-20 |
| 135-136, 139-176 | 37.0 | 4.60-8.75 | 90-100 |
| 177, 183-184, 195 | 28.8-31.3 | 6.75-7.65 | 10-40 |
| 178-182, 185-194, 196-203 | 28.2-31.3 | 4.45-9.45 | 100 |
| 204-205, 207, 217-218 | 27.3-28.2 | 5.35-8.45 | 0 |
| 206, 208-216, 219-231 | 26.0-28.2 | 4.45-9.40 | 90-100 |
| 232 | 26.0 | 6.50 | 0 |
| 233-244 | 24.0-26.0 | 5.45-8.25 | 100 |
| 245 | 23.7 | 7.25 | 50 |
| 246-254 | 20.5-23.7 | 5.15-8.10 | 90-100 |
| 255 | 20.5 | 4.55 | 10 |

Gliadins

| | | | |
|---|---|---|---|
| 1-7 | 49.50-49.95 | 8.45-9.95 | 100 |
| 8, 13 | 42.80-45.00 | 6.75-6.80 | 20 |
| 9, 14 | 42.40-43.85 | 6.95-9.35 | 60 |
| 10-11, 12, 15-28 | 37.50-43.75 | 6.60-7.85 | 90-100 |
| 29, 37 | 35.20-37.10 | 7.50-7.55 | 60-70 |
| 30-36, 38-45 | 34.00-37.10 | 6.60-9.70 | 100 |
| 46, 56 | 31.90-33.20 | 6.90-7.05 | 10 |
| 47-54, 55, 57, 59 | 30.60-32.30 | 6.75-9.75 | 90-100 |
| 58, 67 | 27.40-30.80 | 6.95-7.55 | 60-70 |
| 60-61, 64 | 28.40-30.10 | 6.70-7.20 | 10-20 |
| 62-63, 65-66, 68-77 | 17.50-28.65 | 6.25-9.30 | 100 |

Glutenins

| | | | |
|---|---|---|---|
| 1-3, 7 | 85.2-97.4 | 5.60-8.00 | 0 |
| 4, 9-10, 12, 14 | 68.2-92.3 | 7.75-8.40 | 20-30 |
| 5-6, 13, 15-46, 48-52 | 53.3-90.2 | 5.50-8.65 | 100 |
| 8, 11 | 74.5-81.3 | 7.80-8.10 | 50-60 |
| 47, 55, 58, 60 | 49.5-55.1 | 5.60-6.45 | 10-20 |
| 53-54, 56-57, 59, 62, 64 | 47.4-52.1 | 5.15-6.65 | 60-80 |
| 61, 63, 65-76 | 44.9-49.3 | 4.50-8.60 | 90-100 |
| 77-78 | 44.8 | 5.90-6.25 | 0 |
| 79-100 | 41.8-44.7 | 4.50-8.65 | 80-100 |
| 101, 103, 105 | 41.1-41.6 | 6.50-7.45 | 60-80 |
| 102, 104, 106-107 | 41.1-41.6 | 5.00-7.25 | 90-100 |
| 108 | 41.0 | 6.70 | 30 |
| 109-126, 128-151 | 36.0-41.0 | 4.50-8.25 | 80-100 |
| 127, 160 | 34.6-39.5 | 5.70-7.25 | 60 |
| 152, 154, 173-174 | 33.1-36.0 | 6.50-8.50 | 20 |
| 153-159, 161-172, 175-178 | 31.8-35.8 | 4.75-8.90 | 90-100 |
| 179-180, 182 | 31.5-31.7 | 6.75-8.10 | 40-50 |
| 181, 184, 186-187 | 31.3-31.5 | 5.00-7.65 | 100 |
| 183, 188-189, 214 | 26.3-31.5 | 7.10-8.75 | 0-20 |
| 185, 190-213, 215-221 | 26.3-31.3 | 4.75-9.10 | 80-100 |
| 222 | 26.3 | 6.30 | 40 |
| 223-235, 237-238 | 25.7-26.2 | 4.75-9.30 | 90-100 |
| 236 | 25.8 | 5.50 | 0 |
| 239-240, 260 | 23.0-25.7 | 6.25-6.80 | 60-80 |
| 241-259, 261-275, 277-278 | 19.4-25.6 | 4.50-8.65 | 90-100 |
| 276 | 19.6 | 6.60 | 50 |

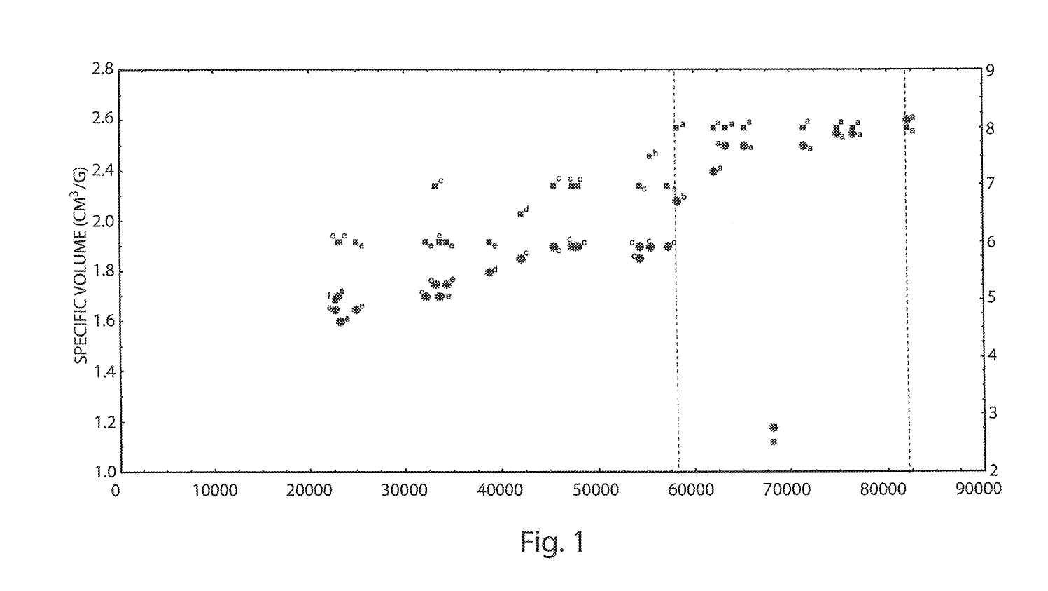

^{a}Analyses were performed with Image Master software (Amersham Pharmacia Biotech, Uppsala, Sweden). Four gels of independent replicates were analyzed.
^{b}Spot designation correspond to those of the gels in FIGS. 1S, 2, and 3.

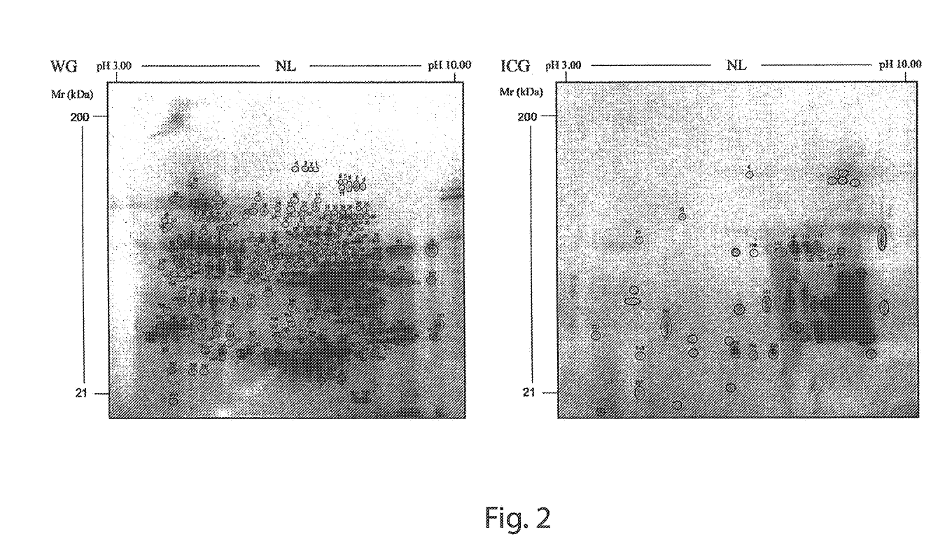

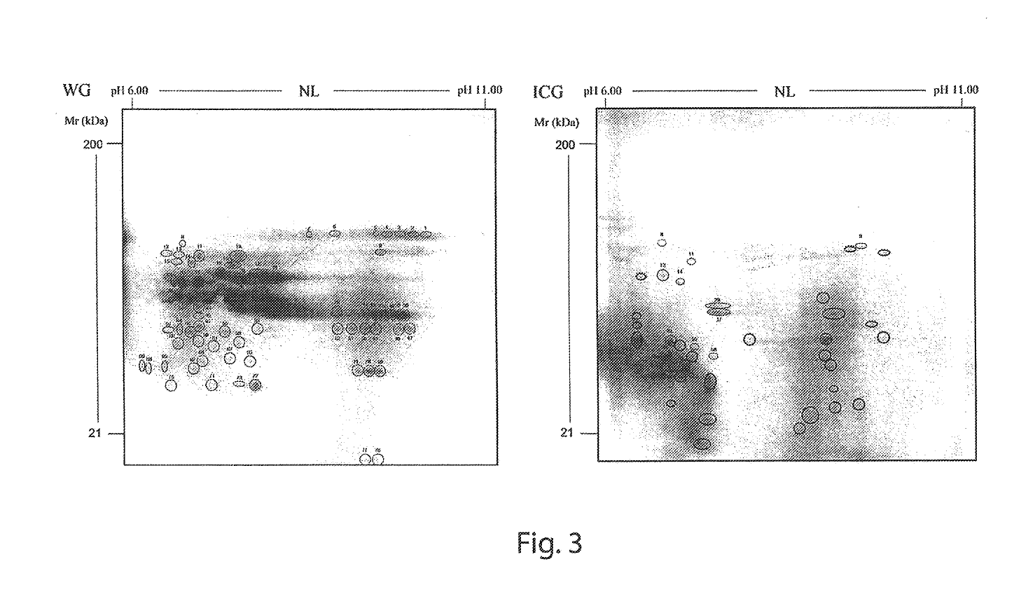

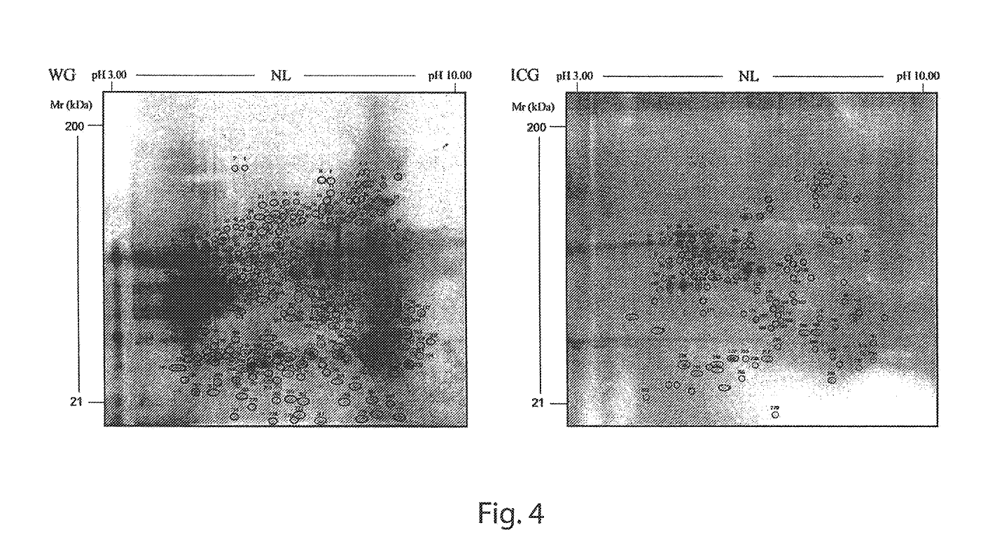

Two-DE analysis of WG flour resolved 255 albumin/globulin polypeptides with pls that ranged from 4.10 to 9.45, and molecular masses (Mr) from 20.5 to 75.4 kDa. Only 28 of them persisted in ICG flour (Table 1 and FIG. 2). The major part of the above spots was hydrolyzed during fermentation with lactic acid bacteria and fungal proteases. In particular, ICG flour showed hydrolysis of 80-100% of 236 protein spots. Seventy-seven gliadin polypeptides were detected in WG flour, having pls that varied from 6.25 to 9.95, and Mr from 17.5 to 50.0 kDa (Table 1 and FIG. 3). Fifteen gliadin polypeptides persisted in ICG flour. A marked hydrolysis (65 to 100%) was found, especially for 77 protein spots that were mainly located in the range of pl from 6.5 to 7.5. The glutenin fraction of WG flour contained 278 polypeptides (pl 4.50-9.30 and molecular mass 97.4-19.4 kDa) (Table 1 and FIG. 4). During fermentation, 249 of them were hydrolyzed by 80 to 100%. The more intense spots, which resolved in the acidic part of the WG gel, almost disappeared in ICG flour.

### C. RP-FPLC Analysis and Analysis of Free Amino Acids Profile

The water/salt-soluble extract of wheat flour, which was prepared according to Weiss et al. (“Electrophoretic characterization of wheat grain allergens from different cultivars involved in bakers' asthma,” 1993, Electrophoresis, 14, 805-816), was used to analyze peptides and free amino acids. Peptide profiles were obtained by reversed-phase fast protein liquid chromatography (RP-FPLC), using a Resource RPC column and AKTA FPLC equipment, with a UV detector operating at 214 nm (GE Healthcare Bio-Sciences AB, Uppsala, Sweden). A volume of water/salt-soluble extract containing ca. 1 mg of peptides, as determined by the o-phtaldialdehyde (OPA) method (Church et al., 1983, “Spectrophotometric assay using o-phthaldialdehyde for determination of proteolysis in milk and isolated milk proteins,” Journal of Dairy Science, 66, 1219-1227), was added to 0.05% (vol/vol) trifluoroacetic acid (TFA), centrifuged at 10,000×g for 10 min, and the supernatant was filtered through a Millex-HA 0.22 μm pore size filter (Millipore Co.) and loaded onto the column. Gradient elution was performed at a flow rate of 1 ml/min using a mobile phase composed of water and acetonitrile (CH₃CN), containing 0.05% TFA. The CH₃CN content was increased linearly from 5 to 46% between 16 and 62 min.

Free amino acids were analyzed by a Biochrom 30 series Amino Acid Analyzer (Biochrom Ltd., Cambridge Science Park, England) with a Na-cation-exchange column (20 by 0.46 cm internal diameter) as described by Rizzello et al. (“Effect of sourdough fermentation on stabilization, and chemical and nutritional characteristics of wheat germ,” Food Chemistry, 119, 1079-1089, 2010).

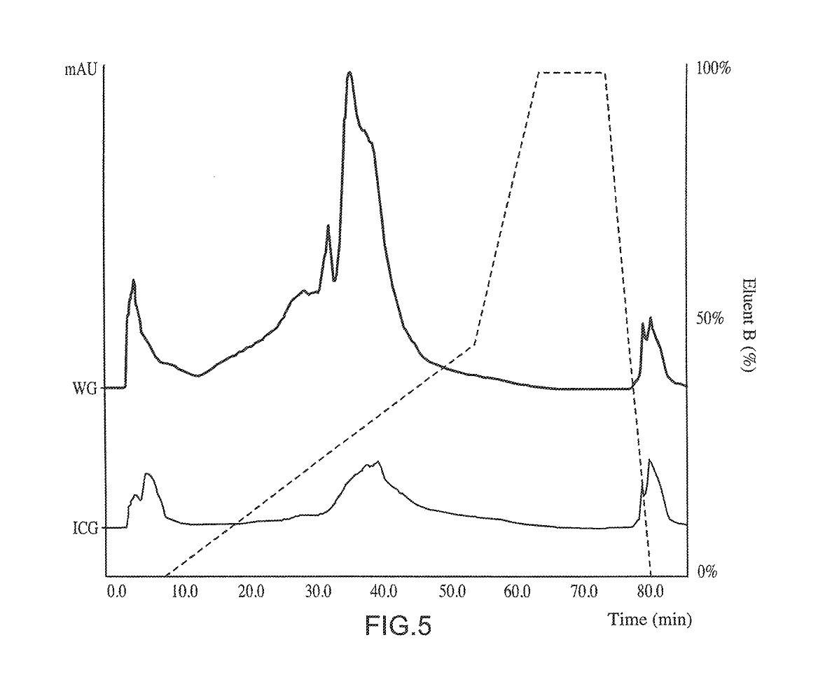

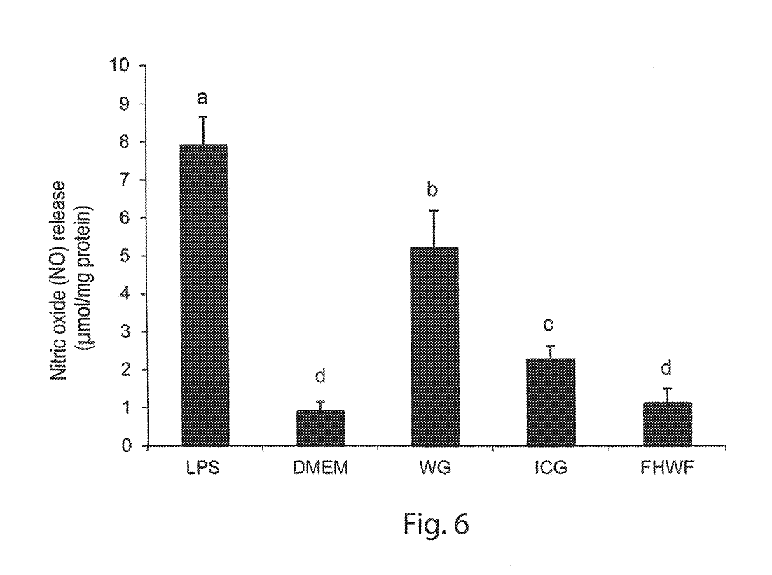

RP-FPLC analyses of the water/salt soluble extracts from WG and ICG flours showed that a marked increase of the peptide peak area occurred during fermentation (FIG. 5). Compared to WG, the main differences found in the peptide profile of ICG flour concerned the hydrophilic zone of the chromatogram and the elution interval from 20 to 45% of the acetonitrile gradient. The concentration of total free amino acids (FAA) of WG flour was 677±26 mg/kg. This value increased to 6,285±67 mg/kg in ICG flour. The profile of FAA differed in part between the two flours (FIG. 6). Asp, Glu, and Trp were found at the highest concentrations in WG flour, while Leu, Glu, Phe and Asp were mainly found in ICG flour.

### D. Agglutination Activity

Gliadins and glutenins from WG and ICG flours were subjected to sequential pepsin and trypsin (PT) hydrolysis to simulate the in vivo digestion (De Angelis et al., 2005, “VSL#3 probiotic preparation has the capacity to hydrolyze gliadin polypeptides responsible for celiac sprue,” Biochimica et Biophysica Acta (BBA)—Molecular Basis of Disease, 1762, 80-93). After digestion, the PT-digest was heated at 100° C. for 30 min to inactivate enzymes and freeze-dried for further analysis. The concentration of proteins of the PT-digest was determined (Lowry et al., “Protein measurement with the folin phenol reagent,” Journal Biological Chemistry, 193, 265-275, 1951). K 562(S) subclone of human myelagenous leukaemia origin from the European Collection of Cell Cultures (Salisbury, United Kingdom) were used for the agglutination assays (Auricchio et al., “Agglutination activity of gliadin-derived peptides from bread wheat: Implications for coeliac disease pathogenesis,” Biochemical and Biophysical Research Communications, 21, 428-433, 1984). Cells were grown on RPMI medium (GIBCO, Invitrogen, Carlsbad, Calif., USA), supplemented with 10% (vol/vol) fetal calf serum (Flow Laboratories, Irvine, Scotland), at 37° C. for 96 h, under humidified atmosphere with 5% CO₂. After cultivation, human cells were harvested by centrifugation at 900×g for 5 min, washed twice with 0.1 M phosphate-buffer saline solution (Ca²⁺ and Mg²⁺ free; pH 7.4) (PBS), and re-suspended in the same buffer at the density of 10⁸ cells/ml. Twenty-five microliters of this cell suspension were added to wells of a microtiter plate, containing serial dilutions (0.1 to ca. 7.0 mg/ml) of PT-digest. The total volume in the well was 100 μl, and the mixture was held for 30 min at room temperature. Following incubation, a drop of the suspension was applied to a microscope slide to count clumped and single cells. Agglutination tests were carried out in triplicate, and photographs were taken with a Diaphot-TMD inverted microscop (Nikon Corp., Tokyo, Japan).

When WG and ICG flours were subjected to pepsin and trypsin (PT) hydrolysis to mimic the in vivo protein digestion (Di Cagno et al., 2002, “Proteolysis by sourdough lactic acid bacteria: effects on wheat flour protein fractions and gliadin peptides involved in human cereal intolerance,” Applied and Environmental Microbiology, 68, 623-33), no significant evidence of cell clustering was found for the undifferentiated K562 (S) cells in the untreated control. On the contrary, the PT-digest from WG flour caused 100% of cell agglutination at the Minimal Agglutinating Capacity (MAC) of 0.11 mg/ml. The MAC of the PT-digest from ICG flour increased to 0.88 mg/ml.

### E. Nitric Oxide Production

Human colon adenocarcinoma T84 cells (ATCC catalogue No. CCL-248, Manassas, Va., United States) were used to determine the release of nitric oxide (NO). Cells were grown on culture medium, containing a mixture (1:1) of Ham's F-12 nutrient and DMEM (Dulbecco's modified Essential medium), which was supplemented with 10% (wt/vol) of heat-inactivated fetal bovine serum (FBS), 2 mM L-glutamine, 15 mM HEPES (4-(2-hydroxyethyl)-1-piperazineethanesulfonic acid), 14.3 mM NaHCO₃ and 50 μg/ml of penicillin/streptomycin. Cells were maintained in 25 cm² culture flasks (Corning Costar, Acton, Mass., United States) at 37° C., under humidified atmosphere with 5% CO₂. The culture medium was replaced three times per week. Passage was carried out at 75-85% of confluence. Cells were seeded in 24-well cell culture plates with ca. 2×10⁴ cells per well, and treated for 24 h with PT-digest at the final concentration of 500 μg/ml. The level of NO was determined by measuring the stable oxidation products nitrite and nitrate in the cell culture supernatants (Green et al., 1982, “Analysis of nitrate, nitrite and nitrate in biological fluids,” Analytical Biochemistry, 126, 131-138). The reaction was carried out on 96 well-plates. Supernatants were mixed with an equal volume of Griess reagent (Sigma Aldrich, St. Louis Mo., USA) (1%, wt/vol, sulphanilic acid in 0.5 M HCl and 0.1%, wt/vol, N¹-1-napthylethylendiamine hydrochloride) and the absorbance at 540 nm was measured after 30 min by a microplate reader (Bio Rad, Hercules, Calif.). The nitrite concentration was determined by reference to a standard curve of sodium nitrite. Fully hydrolyzed wheat flour (Rizzello et al., 2007, “Highly efficient gluten degradation by lactobacilli and fungal proteases during food processing: new perspectives for celiac disease,” Applied and Environmental Microbiology, 73, 4499-4507) was used as the negative control.

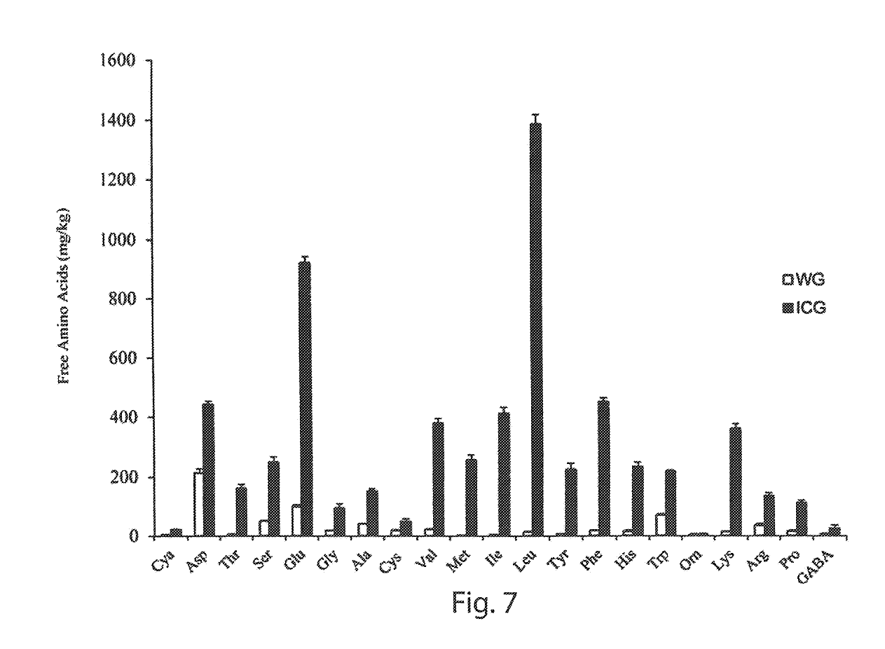

Human colon adenocarcinoma T84 cells have the capacity to release nitrogen oxides (NO₂⁻, NO₃⁻, NO) in the presence of inhibitors and natural toxins (Lande et al., 2000, “Regulation of nitric oxide production in cultured human T84 intestinal epithelial cells by nuclear factor-jB-dependent induction of inducible nitric oxide synthase after exposure to bacterial endotoxin,” Alimentary Pharmacology and Therapeutics, 14, 945-954), including the exposure to wheat gliadin PT-digest (Bethune et al., 2009, “Interferon-gamma released by gluten-stimulated celiac disease-specific intestinal T cells enhances the transepithelial flux of gluten peptides,” Journal of Pharmacology and Experimental Therapeutics, 329, 657-668). As expected, treatment with fully hydrolyzed wheat flour (FHWF) (Rizzello et al., 2007, “Highly efficient gluten degradation by lactobacilli and fungal proteases during food processing: new perspectives for celiac disease,” Applied and Environmental Microbiology, 73, 4499-4507) behaved as the culture medium (DMEM) (FIG. 7). On the contrary, the treatment of T84 cells with the PT-digest from WG flour markedly increased the release of nitrogen oxides. Compared to WG, the release of nitrogen oxides decreased by ca. 40% when T84 cells were exposed to the PT-digest from ICG flour.

### Example 4

### Preparation and Characterization of Breads

After fermentation, sourdoughs were freeze-dried to remove water. After drying and milling, the resulting flour was analyzed and used for bread making. Breads (dough yield of 160) were manufactured at the pilot plant of the Department of Soil, Plant and Food Sciences. A wheat flour bread, which contained non hydrolyzed wheat flour, was manufactured according to the protocol routinely used for typical Italian bread (Gobbet, 1998, “The sourdough microflora: Interactions of lactic acid bacteria and yeasts,” Trends in Food Science and Technology, 9, 267-274), and used as the control.

For bread making, 241 g of non hydrolyzed or fermented flour, 150 ml tap water and 2% (wt/wt) of baker's yeast (corresponding to the final cell density of ca. 10⁷ cfu/g) were mixed at 60×g for 5 min, with a IM 5-8 high-speed mixer (Mecnosud, Flumeri, Italy). Fermentation was at 30° C. for 1.5 h. Before baking, pH and total titratable acidity (TTA) were measured. TTA was determined after homogenization of 10 g of sample with 90 ml of distilled water, and expressed as the amount (ml) of 0.1 M NaOH needed to get the value of pH of 8.3. All breads were baked at 220° C. for 30 min (Combo 3, Zucchelli, Verona, Italy). Moisture was determined according to the standard AACC method (AACC, 2003). Fermentations were carried out in triplicate and each bread was analyzed twice for structural (e.g. specific volume) and sensory features.

### Example 5

### Characterization of Breads

### A. Structural/Textural Analysis and Image Analysis

Instrumental Texture Profile Analysis (TPA) was carried out with a TVT-300×P Texture Analyzer (TexVol Instruments, Viken, Sweden), equipped with a cylinder probe P-Cy25S. For the analysis, boule shaped loaves (300 g) were baked, packed in polypropylene micro perforated bags and stored for 24 h at room temperature. Crust was not removed. The selected settings were as follows: test speed 1 mm/s, 30% deformation of the sample and two compression cycles (Gámbaro et al., 2004, “Consumer acceptability compared with sensory and instrumental measures of white pan bread: sensory shelf-life estimation by survival analysis,” Journal of Food Science, 69, 401-405; Rizzello et al., 2012, “Micronized by-products from debranned durum wheat and sourdough fermentation enhanced the nutritional, textural and sensory features of bread,” Food Research International, 46, 304-313). The Texture Analyzer TVT-XP 3.8.0.5 software was used (TexVol Instruments). Specific volume, height, width, depth and area of loaves were measured by the BVM-test system (TexVol Instruments). The following textural parameters were obtained by the texturometer software: hardness (maximum peak force); fracturability (the first significant peak force during the probe compression of the bread); and resilience (ratio of the first decompression area to the first compression area).

The chromaticity co-ordinates of the bread crust (obtained by a Minolta CR-10 camera) were also reported in the form of a color difference, dE*_{ab}, as follows: dE*_{ab}=\sqrt{(dL)²+(da)²+(db)²} where dL, da, and db are the differences for L, a, and b values between sample and reference (a white ceramic plate having L=93.4, a=−1.8, and b=4.4).

The crumb features of breads were evaluated after 24 h of storage using the image analysis technology. Images of the sliced breads were scanned full-scale using an Image Scanner (Amersham Pharmacia Biotech, Uppsala, Sweden), at 300 dots per inch and analyzed in grey scale (0-255). Image analysis was performed using the UTHSCSA ImageTool program (Version 2.0, University of Texas Health Science Centre, San Antonio, Tex., available by anonymous FTP from maxrad6.uthscsa.edu). A threshold method was used for differentiating gas cells and non-cells (Gámbaro et al., 2004, “Consumer acceptability compared with sensory and instrumental measures of white pan bread: sensory shelf-life estimation by survival analysis,” Journal of Food Science, 69, 401-405; Rizzello et al., 2012, “Micronized by-products from debranned durum wheat and sourdough fermentation enhanced the nutritional, textural and sensory features of bread,” Food Research International, 46, 304-313).

After few hours of baking, the values of moisture did not significantly (P>0.05) differ between breads made with WG and ICG flours (Table 2). The treatment with lactic acid bacteria and fungal proteases only slightly affected the structural, image and color features of the resulting bread (Table 2). Compared to bread made with WG flour, the specific volume of the bread made with ICG flour only slightly (P<0.05) decreased. As shown by the textural profile analysis (TPA), also the hardness was only slightly the highest when the ICG flour was used. On the contrary, the fracturability point, corresponding to the force at the first significant break during compression of the bread, was significantly (P<0.05) the lowest for the bread made with ICG flour. Resilience indicates how well a product fights to regain its original position. The values of resilience showed an opposite trend compared to hardness. The crumb grain of the two breads was evaluated by image analysis technology. Digital images were pre-processed to estimate crumb cell-total area through a binary conversion (Table 2). Compared to bread made with WG flour, the cell-total area (corresponding to the black pixel total area) of the bread from ICG was only slightly lower. This latter bread also showed the lowest crust lightness (L) and the highest value of dE*_{ab}.

TABLE 2
Moisture, structural, and image and color characteristics of breads
made with whole gluten (WG) and intermediate content of gluten
(ICG) flours. ICG wheat flour was fermented with fungal proteases
and selected lactic acid bacteria at 30° C. for 15 h.

| | WG | ICG |
|---|---|---|
| Moisture | 29.7 ± 0.3 | 30.1 ± 0.4 |
| Structural characteristics | | |
| Specific volume (cm³/g) | 2.4 ± 0.02^{a} | 2.08 ± 0.03^{b} |
| Hardness (g) | 3204 ± 12^{b} | 3472 ± 11^{a} |
| Resilience | 0.85 ± 0.03^{a} | 0.71 ± 0.02^{b} |
| Fracturability (g) | 3070 ± 4^{a} | 2382 ± 7^{b} |
| Image analysis | | |
| Black pixel area (%) | 40.7 ± 0.3^{a} | 38.0 ± 0.1^{b} |
| Color analysis (crust) | | |
| L | 65.4 ± 0.2^{a} | 52.3 ± 0.2^{b} |
| a | 7.5 ± 0.1^{b} | 13.2 ± 0.2^{a} |
| b | 31.9 ± 0.2^{a} | 31.1 ± 0.3^{b} |
| dE | 40.3 ± 0.3^{b} | 51.3 ± 0.4^{a} |

Data are the mean of three independent fermentations twice analyzed.
^{a-b}Values in the same row with different superscript letters differ significantly (P < 0.05).

FIG. 1 shows the specific volume and the score for overall acceptability of breads made with wheat flour, which was subjected to various extent of gluten degradation. Their attributes were compared to those of the bread (whole gluten, WG) made with untreated wheat flour. Overall, the specific volume of the breads was strictly related to the residual concentration of gluten. Nevertheless, no significant (P>0.05) differences were found between WG and breads made with wheat flour, having an intermediate content of gluten (ICG) that varied from 62,120±508 to 76,431±400 ppm. In particular, the values of specific volume progressively worsened when the residual concentrations of gluten were less than 58,175±320 ppm. Eight breads had scores of overall acceptability similar (P<0.05) to the control bread made with WG. Among them, the bread made with wheat flour, which was subjected to sourdough fermentation at dough yield of 250 for 15 h and with 50 ppm of fungal proteases, showed the lowest concentration of residual gluten (58,175±320 ppm). This bread had a specific volume significantly (P<0.05) but slightly different from that of WG (2.08 vs. 2.40 cm³/g). Under our experimental conditions, this bread seemed to combine the lowest concentration of residual gluten (degradation of ca. 28% of native immune reactive gluten) with structural and sensory features, which were comparable to those of the traditional bread. It was used for further comparative characterizations.

### B. Sensory Analysis

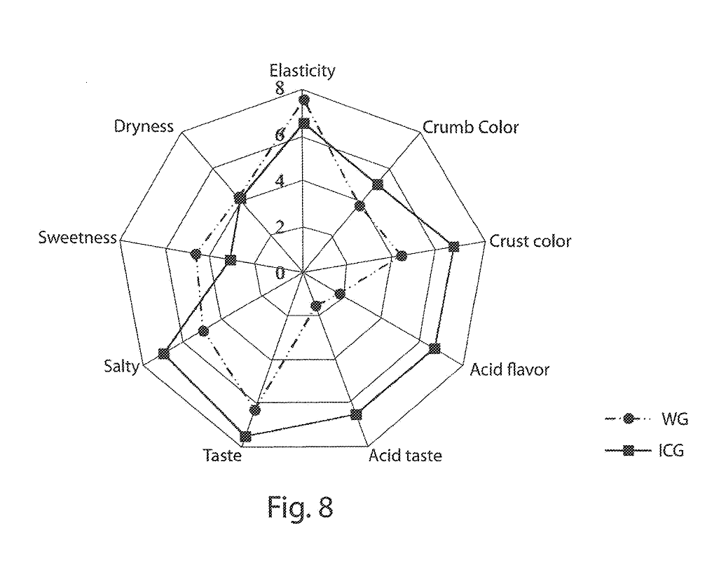

Four hours after baking, the sensory analysis was carried out (FIG. 8) by 10 panellists (5 male and 5 female, mean age: 35 years, range: 18-54 years). Preliminarly, for the selection of the sourdough fermentation parameters, only the overall acceptability was evaluated, using a scale from 0 to 10.

The sensory analysis of the mild-gluten and control breads was carried out according to the method described by Haglund et al. (“Sensory evaluation of wholemeal bread from ecologically and conventionally grown wheat,” Journal of Cereal Science, 27, 199-207, 1998). Elasticity, color of crust and crumb, acid taste, acid flavour, sweetness, dryness, and taste were considered as sensory attributes using a scale from 0 to 10, with 10 the highest score. Salty taste, previously described as another wheat sourdough bread attribute, was also included (Lotong et al., 2000, “Determination of the sensory attributes of wheat sourdough bread,” Journal of Sensory Studies, 15, 309-326; Rizzello et al, 2010, “Use of sourdough fermented wheat germ for enhancing the nutritional, texture and sensory characteristics of the white bread,” European Food Research and Technology, 230, 645-654). The sensory attributes were discussed with the assessors during the introductory sensory training sessions. Samples were served in random order and evaluated in two replicates by all panellists. During preparation for sensory analysis, the loaves were thawed at room temperature for 5-6 h, and then cut into slices 1.5 cm thick. Slices were cut into 4 pieces and each assessor received 2 pieces per sample.

Compared to WG, the use of the ICG flour was responsible for the increase of the scores for acid flavor and taste, overall taste, and salty. The largest difference between the two breads was found for the acid taste attribute. The values of elasticity and dryness were almost the same between the two breads. Compared to bread made with WG, the visual inspection of the bread made with ICG flour showed a significant (P<0.05) increase of the crumb and crust color.

C. Nutritional characterization

The in vitro digestibility of breads was determined by the method of Akeson & Stahman (“A pepsin pancreatin digest index of protein quality evaluation,” Journal of Nutrition, 83, 257-261, 1964). A known amount of sample was incubated with 1.5 mg of pepsin, in 15 ml of 0.1M HCl, at 37° C. for 3 h. After neutralization with 2M NaOH and addition of 4 mg of pancreatin, in 7.5 ml of phosphate buffer (pH 8.0), 1 ml of toluene was added to prevent microbial growth, and the solution was incubated for 24 h at 37° C. After 24 h, the enzyme was inactivated by addition of 10 ml of trichloroacetic acid (20%, wt/vol), and the undigested protein was precipitated. The volume was made up to 100 ml with distilled water and centrifuged at 5000 rpm for 20 min. The concentration of protein of the supernatant was determined by the Bradford method (Bradford, 1976, “A rapid and sensitive method for the quantitation of microgram quantities of protein utilizing the principle of protein-dye binding,” Analytical Biochemistry, 72, 248-254). The precipitate was subjected to protein extraction, according to Weiss et al. (“Electrophoretic characterization of wheat grain allergens from different cultivars involved in bakers' asthma,” Electrophoresis, 14, 805-816, 1993), and the concentration of protein was determined. The in vitro protein digestibility was expressed as the percentage of the total protein, which was solubilized after enzyme hydrolysis.

The supernatant, which contained the digested protein, was freeze-dried and used for further analyses. The modified method of AOAC 982.30a (Association of Official Analytical Chemist, 1990, “Dairy Products,” in: Cunniff, P. (Ed.), Official Methods of Analysis, 15^{th} Ed. Association of Official Analytical Chemists Inc., Arlington, p. 1096-1097) was used to determine the total amino acid profile. The digested protein fraction, which derived from 1 g of sample, was added of 5.7 M HCl (1 ml/10 mg of proteins), under nitrogen stream, and incubated at 110° C. for 24 h. Hydrolysis was carried out under anaerobic conditions to prevent the oxidative degradation of amino acids. After freeze-drying, the hydrolysate was re-suspended (20 mg/ml) in sodium citrate buffer, pH 2.2, and filtered through a Millex-HA 0.22 μm pore size filter (Millipore Co.). Amino acids were analyzed by a Biochrom 30 series Amino Acid Analyzer as described above. Since the above procedure of hydrolysis does not allow the determination of tryptophan, it was estimated by the method of Pintér-Szakács & Molnán-Perl (“Determination of tryptophan in unhydrolysed food and feed stuff by the acid ninhydrin method,” Journal of Agricultural and Food Chemistry, 38, 720-726, 1990). One gram of sample was suspended in 10 ml of 75 mM NaOH, and shaken for 30 min at room temperature. The sample was centrifuged (10,000 rpm for 10 min), and 0.5 ml of the supernatant were mixed with 5 ml of ninhydrin reagent (1 g of ninhydrin in 100 ml of HCl 37%:formic acid 96%, at the ratio 2:3) and incubated for 2 h at 37° C. The reaction mixture was cooled at room temperature and made up to 10 ml with the addition of diethyl ether. The absorbance at 380 nm was measured. A standard tryptophan curve was prepared using a tryptophan (Sigma Chemicals Co.) solution in the range 0-100 μg/ml.

Chemical Score (CS) estimates the amount of protein required to provide the minimal essential amino acid (EAA) pattern, which is present in the reference protein (hen's egg). It was calculated using the equation of Block et al. (“The correlation of the amino acid composition of protein with their nutritive value,” Nutrition Abstracts & Reviews, 16, 249-278, 1946), which compares the content of EAA of the bread for the amount of the same amino acid of the reference. The sequence of limiting essential amino acids corresponds to the list of EAA, having the lowest chemical score (Block et al., 1946). The protein score indicates the chemical score of the most limiting EAA that is present in the test protein (Block et al., 1946). Essential Amino Acids Index (EAAI) estimates the quality of the test protein, using its EAA content as the criterion. EAAI was calculated according to the procedure of Oser (“Method for integrating essential amino acid content in the nutritional evaluation of protein,” Journal of the American Dietetic Association, 27, 396-402, 1951). It considers the ratio between EAA of the test protein and EAA of the reference protein, according to the following equation:

$$EAAI = \sqrt[π]{\frac{( {EAA}_{1} * 100 ) ( {EAA}_{2} * 100 ) ( … ) ( {EAA}_{n} * 100 ) [ sample ]}{( {EAA}_{1} * 100 ) ( {EAA}_{2} * 100 ) ( … ) ( {EAA}_{n} * 100 ) [ reference ]}}$$

The Biological Value (BV) indicates the utilizable fraction of the test protein. BV was calculated using the equation of Oser (“Protein and amino acid nutrition,” Albanese Academic Press, New York, p. 281-291, 1959): BV=([1.09*EAAI]−11.70). The Protein Efficiency Ratio (PER) estimates the protein nutritional quality based on the amino acid profile after hydrolysis. PER was determined using the model developed by lhekoronye (“A Rapid Enzymatic and Chromatographic Predictive Model for the in-vivo Rat-Based Protein Efficiency Ratio,” Ph.D. Thesis, University of Missouri, Columbia, 1981): PER=−0.468+(0.454*[Leucine])−(0.105*[Tyrosine]). The Nutritional Index (NI) normalizes the qualitative and quantitative variations of the test protein compared to its nutritional status. NI was calculated using the equation of Crisan et al. (“Biology and Cultivation of Edible Mushrooms,” Academic Press. New York, p 137-142, 1978), which considers all the factors with an equal importance: NI=(EAAI*Protein(%)/100).

TABLE 3
Nutritional indexes of breads made with whole gluten
(WG) and intermediate content of gluten (ICG) flours.
ICG wheat flour was fermented with fungal proteases and
selected lactic acid bacteria at 30° C. for 15 h.

| | WG | ICG |
|---|---|---|
| In vitro digestibility (%) | 79.2 ± 0.6^{b} | 83.5 ± 0.3^{a} |
| Chemical score (%) | | |
| Histidine | 99 ± 2^{a} | 91 ± 1^{b} |
| Isoleucine | 57 ± 1 | 58 ± 2 |
| Leucine | 78 ± 2 | 79 ± 2 |
| Lysine | 28 ± 3 | 30 ± 2 |
| Cystine | 52 ± 3^{b} | 61 ± 2^{a} |
| Methionine | 32 ± 2 | 30 ± 1 |
| Phenylalanine + Tyrosine | 73 ± 3 | 74 ± 2 |
| Threonine | 56 ± 2^{a} | 52 ± 1^{b} |
| Valine | 64 ± 1 | 64 ± 2 |
| Tryptophan | 62 ± 2^{b} | 78 ± 1^{a} |
| Sequence of limiting essential amino | Lysine | Lysine |
| acids (EAA) | Methionine | Methionine |
| | Cystine | Threonine |
| Protein score (%) | 28 ± 3 | 30 ± 2 |
| Essential Amino Acid Index (EAAI) | 56.7 ± 0.5^{b} | 58.15 ± 0.6^{a} |
| Biological Value (BV) | 49.9 ± 0.4^{b} | 51.7 ± 0.4^{a} |
| Protein Efficiency Ratio (PER) | 28.5 ± 0.6 | 28.5 ± 0.7 |
| Nutritional Index (NI) | 2.84 ± 0.10^{b} | 3.56 ± 0.14^{a} |

Data are the mean of three independent fermentations twice analyzed.
^{a-b}Values in the same row with different superscript letters differ significantly (P < 0.05).

The digestibility of the bread made with ICG was the highest (Table 3). Compared to the bread made with WG flour, it showed an increase of ca. 5%. The digestible protein fraction was further characterized. In particular, the amino acid composition was determined, and the related chemical scores were calculated using the egg essential amino acid (EAA) pattern as the reference (FAO, 1970, “Amino-acid content of foods and biological data on proteins,” FAO Nutritional Studies, 24, 1-285) (Table 3). Cys and Trp had a significant (P<0.05) higher chemical score in the bread made with ICG flour, whereas His and Thr were the highest in the other bread. No significant (P>0.05) differences were found for the other amino acids. Based on the chemical scores, the sequences of limiting amino acids and the protein score were determined. For both breads, Lys and Met were the most limiting amino acids, and no significant (P>0.05) differences were found for the total protein score (Table 3). EAA and Biological Value (BV) indexes, which are commonly used to estimate the quality of food proteins, were significantly (P<0.05) the highest in the bread made with ICG flour. No differences were found for the Protein Efficiency Ratio (PER). Compared to bread made with WG flour, the Nutritional Index (NI), whose calculation also considers quantitative factors, was markedly higher in the bread made with ICG flour.

We claim:

1. A method for preparing flour dough with reduced gluten content from gluten containing flours, comprising:
a. mixing 20-50% by weight of flour with 50-80% by weight of water comprising a mixture of lactic acid bacteria, Lactobacillus sanfranciscensis DSM22063 and Lactobacillus plantarum DSM 22064, wherein each strain of the lactic acid bacteria is at a cell density of about 10⁶-10¹⁰ cfu/g;
b. adding one or more fungal proteases at a final concentration of 10 to 100 ppm; and
c. fermenting the product of step b) to obtain the flour dough with reduced gluten content.

2. The method according to claim 1, further comprising a step of drying the flour dough obtained in step c).

3. The method according to claim 2, wherein the step of drying the flour dough yields a dough yield (ratio between obtained dough weight and weight of starting flour×100) of 140-180.

4. The method according to claim 1, wherein the flour is selected from bread wheat flour, durum wheat flour, barley flour, rye flour, oat flour or a mixture thereof.

5. The method according to claim 1, wherein the fungal proteases are selected from proteases of Aspergillus oryzae, proteases of Aspergillus niger or mixtures thereof.

6. Flour dough with a reduced gluten content obtained by the method of claim 1.

7. Flour dough with a reduced gluten content obtained by the method of claim 2.

8. The flour dough according to claim 6, wherein the gluten content of the flour dough is at least 20,000 ppm.

9. The flour dough according to claim 6, wherein the gluten content of the flour dough is 20,000-80,000 ppm.

10. A method for preparing a baked good with reduced gluten content, comprising:
a. adding baker's yeast and salt to the flour dough obtained by the method of claim 1;
b. kneading the dough obtained in step a);
c. fermenting the dough obtained in step b); and
d. baking the fermented dough obtained in step c) to obtain a baked good with reduced gluten content.

11. A baked good obtained by the method of claim 10.

12. A method for preparing a baked good with reduced gluten content, comprising:
a. adding egg, sugar, butter and baker's yeast to the flour dough obtained by the method of claim 1;
b. kneading the dough obtained in step a);
c. fermenting the dough obtained in step b); and
d. baking the fermented dough obtained in step c) to obtain a baked good with reduced gluten content.

13. A baked good obtained by the method of claim 12.

14. A method for preparing food products for individuals with gluten sensitivity, comprising using the flour dough of claim 6.
